(19) United States
(12) Patent Application Publication
(10) Pub. No.: US 2009/0164802 A1
(43) Pub. Date: Jun. 25, 2009

(54) MEMORY MANAGEMENT METHOD

(75) Inventor: Isacc J. Labaton, Macabim (IL)

Correspondence Address: SNELL & WILMER L.L.P. (Main), 400 EAST VAN BUREN, ONE ARIZONA CENTER, PHOENIX, AZ, 85004-2202, US

(73) Assignee: CIDWAY TECHNOLOGIES, LTD., London (GB)

(21) Appl. No.: 12/335,284

(22) Filed: Dec. 15, 2008

(30) Foreign Application Priority Data
Dec. 19, 2007 (IL) 188254

(51) Int. Cl. G06F 12/14; H04L 9/32

(52) U.S. Cl. 713/189

(57) ABSTRACT

A mobile communicator including a CPU, communications software and application software for at least one application which can be launched only by using at least one application key, the at least one application key being scrambled using a scrambling function which is based on a seed, which seed is not stored in any computer memory used by the mobile communicator.

### CROSS REFERENCE TO RELATED APPLICATIONS

This application claims the right of priority based on Israel Patent Application No. 188254 entitled “MEMORY MANAGEMENT METHOD,” filed on Dec. 19, 2007, which is incorporated herein by reference.

### FIELD OF THE INVENTION

The present invention relates to methods and systems for memory management and for protection of application data stored in mobile communicators, generally.

### BACKGROUND OF THE INVENTION

The following U.S. Patent documents are believed to represent the current state of the art:

U.S. Patent Application Publication No: 2007/0180234.

### SUMMARY OF THE INVENTION

The present invention seeks to provide a system and method for protecting application data in a mobile communicator.

There is thus provided in accordance with a preferred embodiment of the present invention a mobile communicator including a CPU, communications software and application software for at least one application which can be launched only by using at least one application key, the at least one application key being scrambled using a scrambling function which is based on a seed, which seed is not stored in any computer memory used by the mobile communicator.

In accordance with a preferred embodiment of the present invention, following scrambling thereof, the at least one application key is stored in a memory associated with the mobile communicator in a distributed manner. Preferably, the application employs the seed to generate an unscrambling function for unscrambling the at least one application key following retrieval thereof from the memory. Additionally or alternatively, the seed is stored in a computer memory which is not operationally used by the application.

In accordance with another preferred embodiment of the present invention, the application software is associated with personal user information. Preferably, the seed is provided by a user. More preferably, the user provides the seed each time the application is launched.

In accordance with yet another preferred embodiment of the present invention, the application employs the at least one application key for generating a One Time Password (OTP). Additionally or alternatively, the application employs the at least one application key for providing a response to a challenge provided by a challenging server.

In accordance with a further preferred embodiment of the present invention, the at least one application key may be a private key or alternatively the seed for the generation of a private key of a key pair associated with use of an asymmetric algorithm.

There is also provided in accordance with another preferred embodiment of the present invention a method of securing data in a mobile communicator against unauthorized use including providing application software for at least one application which can be launched only by using at least one application key and scrambling the at least one application key by using a scrambling function which is based on a seed, which seed is not stored in any computer memory used by the mobile communicator.

In accordance with a preferred embodiment of the present invention, the method also includes installing and running the at least one application on the mobile communicator. Preferably, the method also includes storing the at least one application key in a memory associated with the mobile communicator in a distributed manner. Additionally or alternatively, the method also includes storing the seed in a computer memory which is not used by the mobile communicator.

In accordance with another preferred embodiment of the present invention, the application software is associated with personal user information. Preferably, the seed is provided by a user. More preferably, the user provides the seed each time the application is launched.

In accordance with yet another preferred embodiment of the present invention, the at least one application key includes a private key forming part of a key pair associated with use of an asymmetric algorithm.

In accordance with a further preferred embodiment of the present invention, the scrambling includes concatenating the at least one application key and a dimension corresponding to each of the at least one application key to form a contiguous vector and employing the seed in a random number generator to generate a scrambling function for scrambling the contiguous vector, thereby to obtain an incontiguous vector. Preferably, the employing the seed in a random number generator to generate a scrambling function includes employing the seed in a random number generator to obtain a random sequence, employing the random sequence as a randomization seed in an algorithm, thereby to obtain a random arrangement, using the random arrangement in the scrambling function and applying the scrambling function, using the random arrangement, to the contiguous vector.

In accordance with an additional preferred embodiment of the present invention, the method also includes employing the application and the at least one application key for generating One Time Passwords (OTPs). Additionally or alternatively, the method also includes employing the application and the at least one application key for providing responses to challenges generated by a challenging server. Preferably, the employing the application and the at least one application key includes retrieving an incontiguous vector representing the at least one application key from a memory associated with the mobile communicator and unscrambling the incontiguous vector using an unscrambling function which is based on the seed, thereby to obtain the at least one application key. Additionally, the unscrambling includes employing the seed in a random number generator to obtain a random sequence, employing the random sequence as a randomization seed in an algorithm, thereby to obtain a random arrangement, using the random arrangement in the unscrambling function, applying the unscrambling function, using the random arrangement, to the incontiguous vector, thereby to obtain a contiguous vector and segmenting the contiguous vector to retrieve the at least one application key.

There is further provided in accordance with a further preferred embodiment of the present invention a computer readable medium including, in computer readable form, application software for at least one application which can be launched only by using at least one application key, the at least one application key being scrambled using a scrambling function which is based on a seed, which seed is not stored in any operational computer memory used by the application.

In accordance with a preferred embodiment of the present invention, the at least one application key is stored in a memory associated with the mobile communicator in a distributed manner. Additionally or alternatively, the application software is associated with personal user information.

In accordance with another preferred embodiment of the present invention the at least one application key that may be a private key or alternatively the seed for the generation of a private key of a key pair associated with use of an asymmetric algorithm. Preferably, the seed is provided by a user each time the application is launched.

There is additionally provided in accordance with an additional preferred embodiment of the present invention a software module suitable for use in a mobile communicator, the software module being launchable only by using at least one application key which is scrambled using a scrambling function which is based on a seed, which seed is not stored in any computer memory used by the mobile communicator.

In accordance with a preferred embodiment of the present invention, the at least one application key is stored in a memory associated with the mobile communicator in a distributed manner. Preferably, the seed is stored in a computer memory which is not used by the application for the regular operation.

In accordance with another preferred embodiment, the at least one application key includes a private key that may be a private key or alternatively the seed for the generation of a private key of a key pair associated with use of an asymmetric algorithm. Preferably, the seed is provided by a user each time the application is launched.

### BRIEF DESCRIPTION OF THE DRAWINGS

The present invention will be understood and appreciated more fully from the following detailed description, taken in conjunction with the drawings in which:

FIGS. 1A, 1B and 1C are simplified illustrative drawings illustrating set up and use of an application key scrambling system in the exemplary context of a mobile banking system;

FIGS. 2A and 2B are simplified illustrative drawings illustrating set up and use of an application key scrambling system in the exemplary context of a gaming system;

FIGS. 3A, 3B and 3C are simplified illustrative drawings illustrating factory set up, home set up and use of an application key scrambling system in the exemplary context of a security related system;

FIGS. 4A and 4B, taken together, are a simplified flowchart illustrating set up procedures employed in accordance with a preferred embodiment of the present invention; and

FIGS. 5A and 5B, taken together, are a simplified flowchart of the operation of the present invention in running a protected application.

### DETAILED DESCRIPTION OF PREFERRED EMBODIMENTS

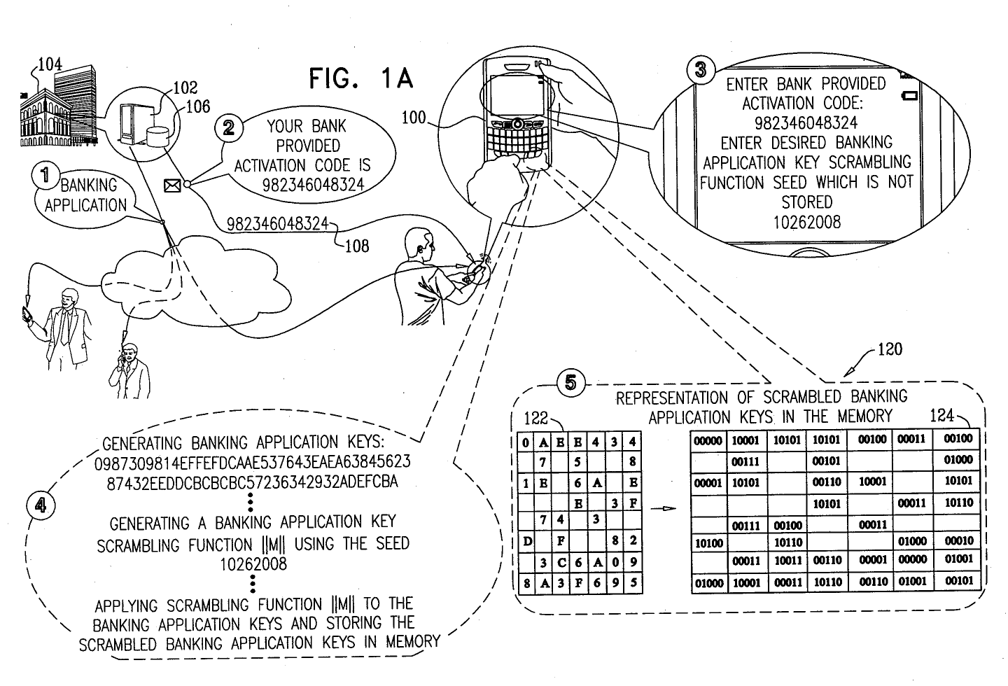

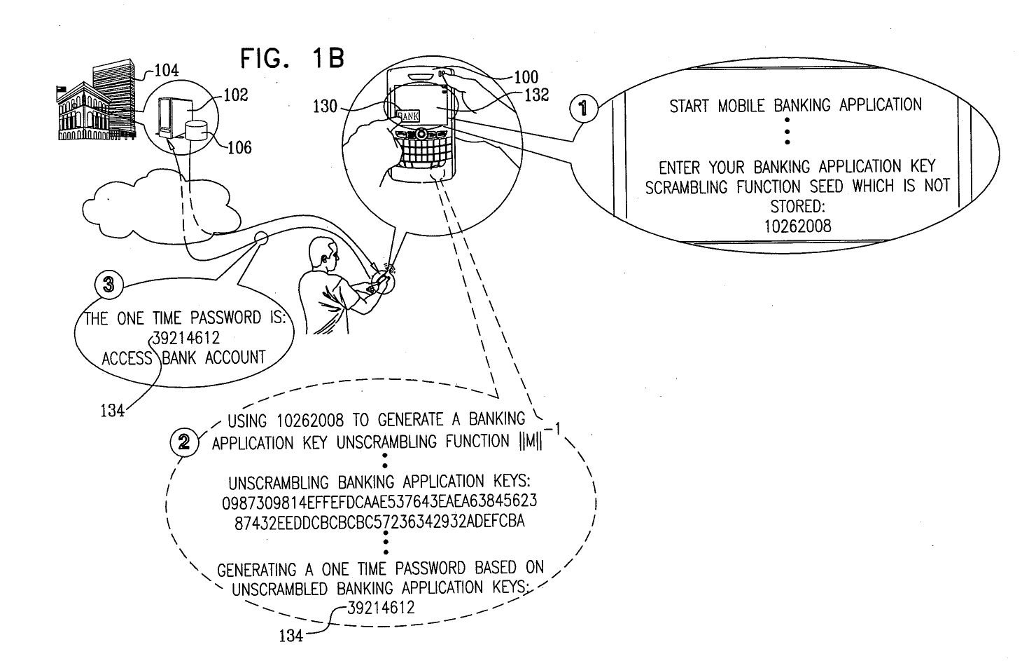

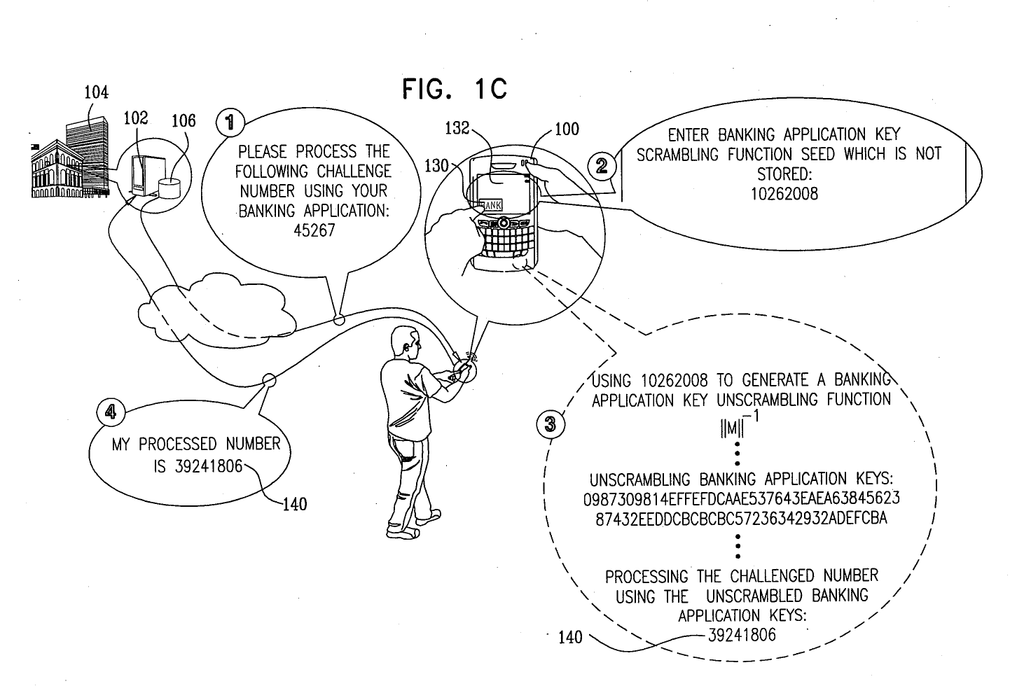

Reference is now made to FIGS. 1A, 1B and 1C, which are simplified illustrative drawings illustrating set up and use of an application key scrambling system in the exemplary context of a mobile banking system.

As seen in FIG. 1A, multiple users are seen downloading to a mobile communicator 100 a mobile banking application from a server 102 associated with a bank 104 (Step 1). A database 106, associated with the bank 104, provides an activation code 108, such as 982346048324, to each user (Step 2). Communication of the activation code 108 to the user may be via any suitable communications link, such as voice, hard copy letter, email, SMS or via server 102. It will be appreciated that the term activation code includes any data received by the user, which enables the user initially to operate his mobile communicator or an application.

Typically, when the user downloads a mobile banking application, the user provides his personal banking information such as a name, branch number and bank account number. The instance of the mobile banking application downloaded by a given user has associated therewith a unique serial number, which is associated with the user's personal banking information. The serial number and the corresponding user's personal banking information are typically stored in database 106.

Following downloading of the mobile banking application, the user is prompted by the application to register, by entering the activation code 108, selecting an application key scrambling function seed, and entering the application key scrambling function seed, using his mobile communicator 100 (Step 3). It is a particular feature of the present invention that the application key scrambling function seed is not stored in any memory used by the user's mobile communicator 100, whether or not that memory is removable or separate from the mobile communicator. However, the application key scrambling function seed may be stored in a computer memory which is not used by the user's mobile communicator, such as on a user's personal computer (not shown).

The downloaded banking application operating on the mobile communicator 100 then generates a plurality of keys, such as:

987309814EFFEFDCAAE537643EAEA63845623; and

7432EEDDCBCBCBC57236342932ADEFCBA.

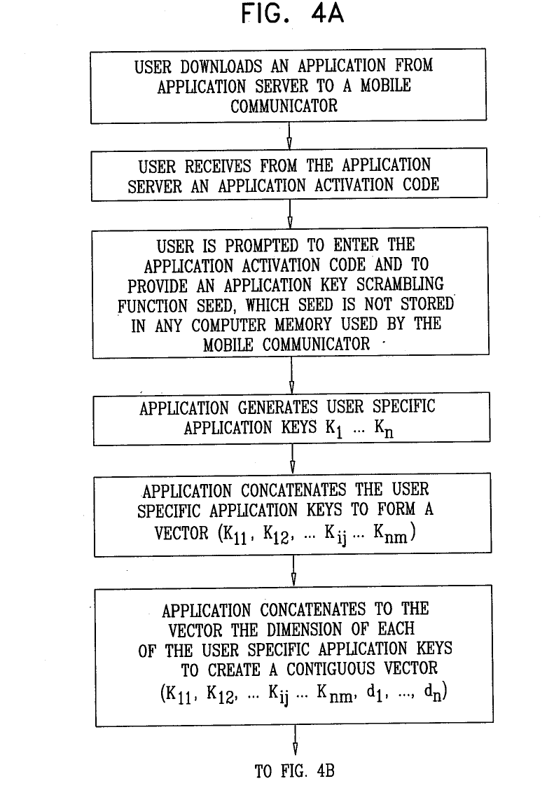

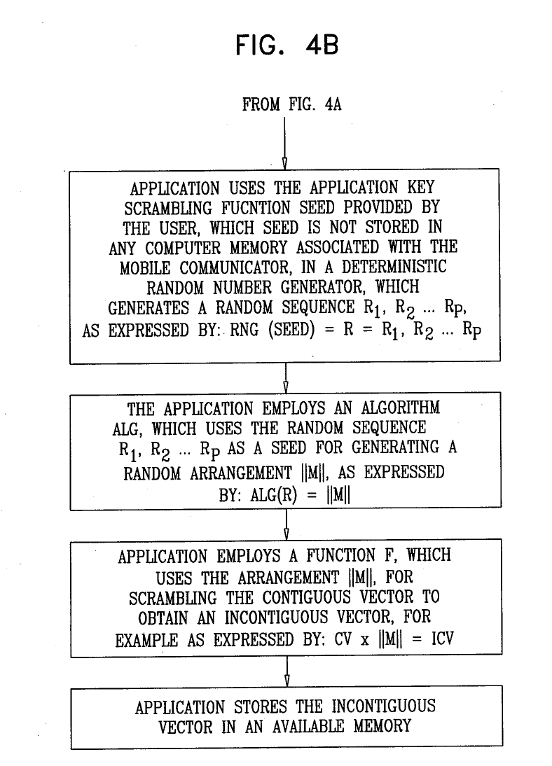

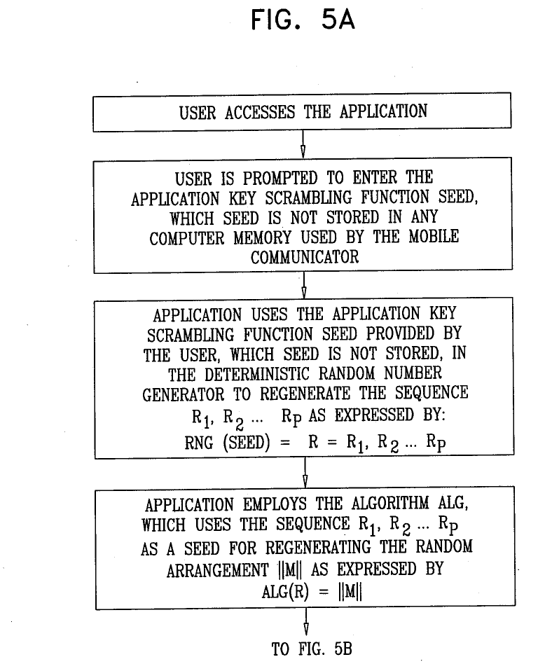

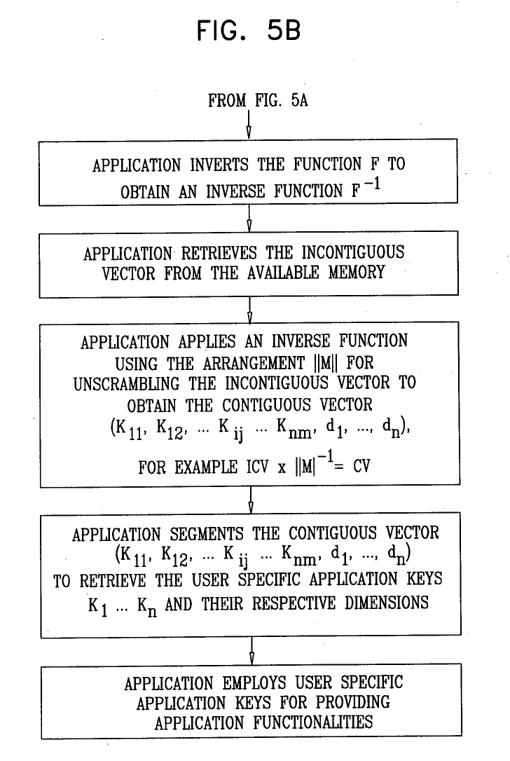

The application then proceeds to generate a scrambling function using the application key scrambling function seed entered by the user, and applies the scrambling function to the plurality of keys to obtain scrambled banking application keys (Step 4). The scrambling process is described in further detail hereinbelow, with reference to FIGS. 4A-5B.

The scrambled banking applications keys are stored in a memory associated with the mobile communicator, such as for example, a SIM card, MMC or mobile memory. (Step 5), as indicated at reference numeral 120. The scrambled banking application keys as stored in the memory are represented in human readable form at reference numeral 122, and in binary form at reference numeral 124.

It is appreciated that in accordance with the present invention the scrambled banking application keys need not necessarily be stored in a contiguous section of the memory, and are preferably distributed within all the available space in the memory being used. Additionally, the banking application keys need not necessarily be stored in areas of the memory which are dedicated to storing application data.

Turning to FIG. 1B, a user is seen launching the mobile banking application on his mobile communicator 100. This may be achieved by touching or clicking on a banking application icon 130 appearing on a display 132 of the mobile communicator, as shown. When the mobile banking application is launched, the user is prompted to enter his application key scrambling function seed, using his mobile communicator 100 (Step 1).

The downloaded banking application operating on the mobile communicator 100 then retrieves the scrambled application keys from their storage locations in the memory and employs the application key scrambling function seed entered by the user to generate an application key unscrambling function, which is typically the inverse of the scrambling function. The banking application proceeds to unscramble the application keys using the unscrambling function, resulting in the original keys, such as:

987309814EFFEFDCAAE537643EAEA63845623; and

7432EEDDCBCBCBC57236342932ADEFCBA.

The unscrambled banking application key are then used as a basis for generating a One Time Password (OTP) 134, such as 39214612 (step 2). Methods for generating an OTP are known in the art, and are described in U.S. Pat. No. 6,957,185 and U.S. Patent Application publication number 2008/0077799, both of which are assigned to the Applicant and the contents of which are hereby incorporated by reference.

The OTP 134 generated by the banking application is then transmitted, via the mobile communicator 100, to the server 102, thereby allowing the user mobile access to his bank account (step 3).

It is appreciated that when the OTP 134 is received at the bank server 102, the server 102 employs the serial number associated with the user's downloaded instance of the mobile banking application for retrieving from database 106 the user's personal banking information.

Optionally, the OTP 134 may be displayed to the user on the display 132 of the mobile communicator 100, such that the user may transmit the OTP 134 to the server 102 via another instance of the mobile banking application. This mode of operation is particularly advantageous when a user wants to access his bank account via a device other than the mobile communicator 100, such as via a personal computer (not shown). It is noted that the other instance of the mobile banking application must also be associated with the user's personal banking information.

Reference is now made to FIG. 1C, which illustrates a user launching the mobile banking application on his mobile communicator 100. This may be achieved by touching or clicking on a banking application icon 130 appearing on a display 132 of the mobile communicator, as shown.

When the mobile banking application is launched, the server 102 transmits a challenge number, such as 45267, to the mobile communicator 100, for processing using the banking application (step 1).

Subsequently or concurrently, the user is prompted to enter his application key scrambling function seed, using his mobile communicator 100 (Step 2).

The downloaded banking application operating on the mobile communicator 100 then retrieves the scrambled application keys from their storage locations in the memory and employs the application key scrambling function seed entered by the user to generate an application key unscrambling function, which is typically the inverse of the scrambling function. The banking application proceeds to unscramble the application keys using the unscrambling function, resulting in the original keys, such as:

987309814EFFEFDCAAE537643EAEA63845623; and

7432EEDDCBCBCBC57236342932ADEFCBA.

The unscrambled banking application keys are then used for processing the challenge number provided by the server 102 (step 3). Typically, a multi-parameter function is employed for this purpose, such that the challenge number comprises one of the parameters of the function, and the unscrambled banking application keys comprise the remaining parameters of the function. In the illustrated embodiment, the challenge response is 39241806, as indicated by reference numeral 140.

The response to the challenge number generated by the banking application is then transmitted, via the mobile communicator 100, to the server 102, thereby allowing the user mobile access to his bank account (step 4).

It is appreciated that when the challenge response is received at the bank server 102, the server 102 employs the serial number associated with the user's downloaded instance of the mobile banking application for retrieving from database 106 the user's personal banking information.

Optionally, the challenge response may be displayed to the user on the display 132 of the mobile communicator 100, such that the user may transmit the challenge response to the server 102 via another instance of the mobile banking application. This mode of operation is particularly advantageous when a user wants to access his bank account via a device other than the mobile communicator 100, such as via a personal computer (not shown). It is noted that the other instance of the mobile banking application must also be associated with the user's personal banking information.

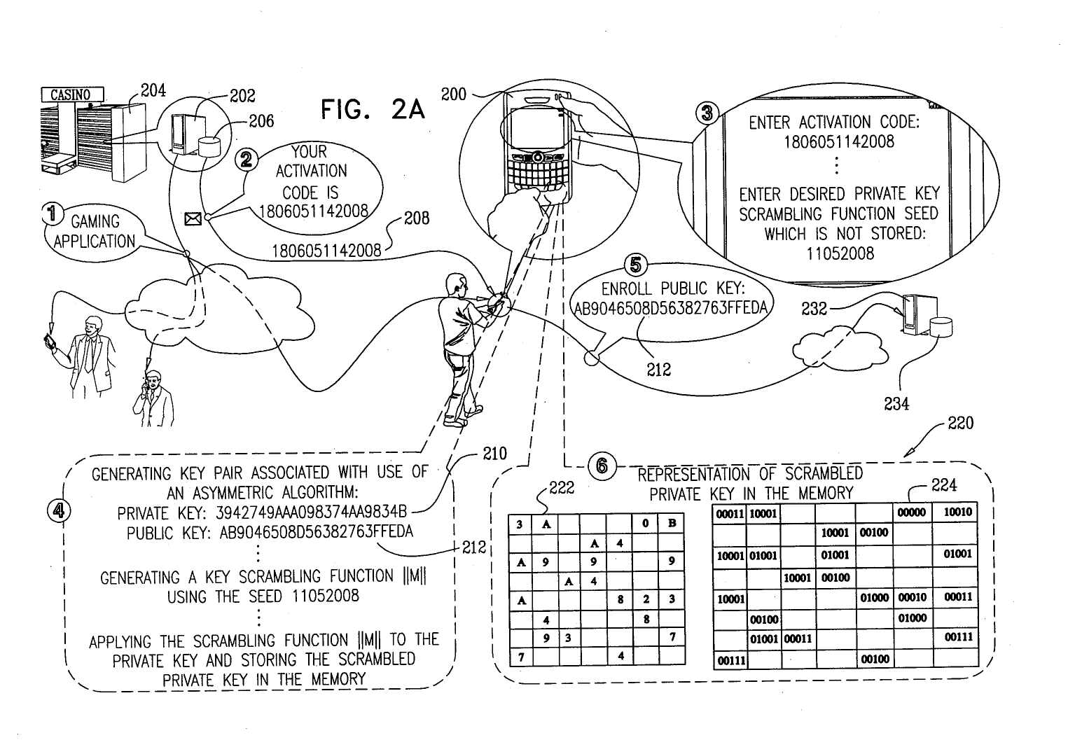

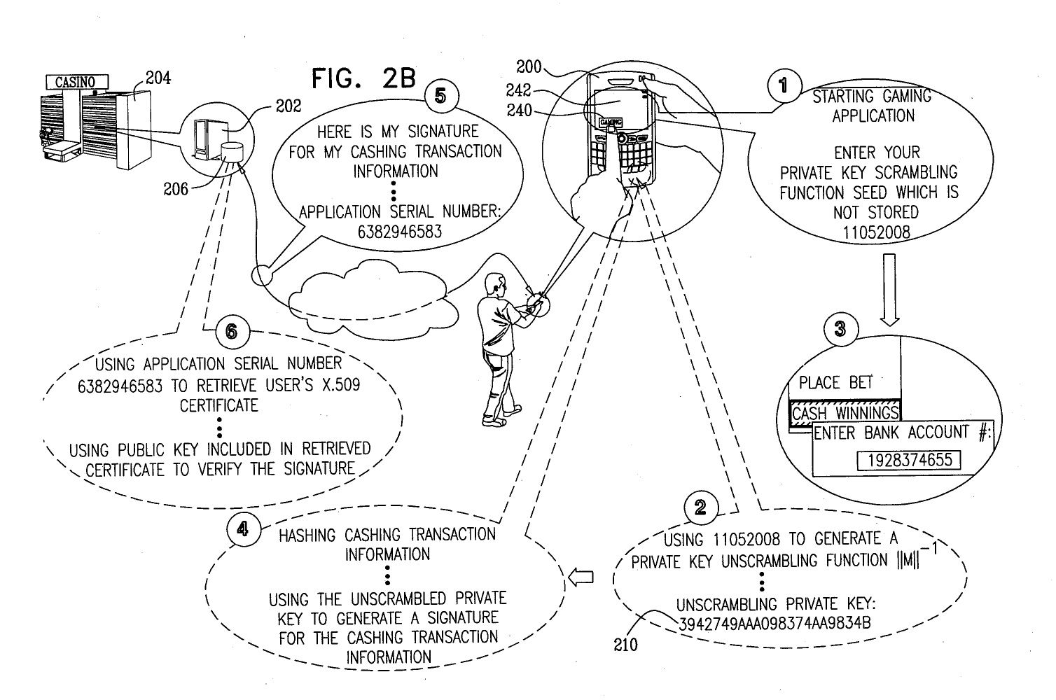

Reference is now made to FIGS. 2A and 2B, which are simplified illustrative drawings illustrating set up and use of an application key scrambling system in the exemplary context of a gaming system.

As seen in FIG. 2A, multiple users are seen downloading to a mobile communicator 200 a mobile gaming application from a server 202 associated with a gaming facility 204 (Step 1). A database 206, associated with the gaming facility 204, provides an activation code 208, such as 18060511408, to each user (Step 2). Communication of the activation code 208 to the user may be via any suitable communications link, such as voice, hard copy letter, email, SMS or via server 202.

Typically, when the user downloads a mobile gaming application, the user provides his personal information such as a name and telephone number. The instance of the mobile gaming application downloaded by a given user has associated therewith a unique serial number, which is associated with the user's personal information. The serial number and the corresponding user's personal information are typically stored in database 206.

Following downloading of the mobile gaming application, the user is prompted by the application to register, by entering the activation code 208, selecting an application key scrambling function seed, and entering the application key scrambling function seed, using his mobile communicator 200 (Step 3). It is a particular feature of the present invention that the application key scrambling function seed is not stored in any memory used by the user's mobile communicator 200, whether or not that memory is removable or separate from the mobile communicator. However, the application key scrambling function seed may be stored in a computer memory which is not used by the user's mobile communicator, such as on a user's personal computer (not shown).

The downloaded gaming application operating on the mobile communicator 200 then generates a key pair associated with the use of an asymmetric algorithm, including:

a private key 210 such as: 3942749AAA098374AA9834B; and

a public key 212 such as: AR9046508D56382763FFEDA.

The application then proceeds to generate a scrambling function using the application key scrambling function seed entered by the user, and applies the scrambling function to the private key 210 to obtain scrambled gaming application private key (Step 4). The scrambling process is described in further detail hereinbelow, with reference to FIGS. 4A-5B.

The scrambled private key is stored in a memory associated with the mobile communicator, such as for example, a SIM card, MMC or mobile memory (Step 5), as indicated by reference numeral 220. The scrambled gaming application keys as stored in the memory are represented in human readable form at reference numeral 222, and in binary form at reference numeral 224.

It is appreciated that in accordance with the present invention the scrambled gaming application private key need not necessarily be stored in a contiguous section of the memory, and is preferably distributed within all the available space in the memory being used. Additionally, the gaming application private key need not necessarily be stored in areas of the memory which are dedicated to storing application data.

The public key 212 is transmitted to an asymmetric algorithm enrollment server 232 having a database 234 associated therewith, for enrollment of the public key and generation of a certificate, such as a X.509 certificate, for the user (step 5). Preferably, a copy of the certificate generated by the server 232 is stored in database 206 of server 202.

Turning to FIG. 2B, a user is seen launching the mobile gaming application on his mobile communicator 200. This may be achieved by touching or clicking on a gaming application icon 240 appearing on a display 242 of the mobile communicator 200, as shown.

When the mobile gaming application is launched, the user is prompted to enter his application key scrambling function seed, using his mobile communicator 200 (Step 1).

The downloaded gaming application operating on the mobile communicator 200 then retrieves the scrambled private key from its storage location in the memory and employs the application key scrambling function seed entered by the user to generate an application key unscrambling function, which is typically the inverse of the scrambling function. The gaming application proceeds to unscramble the private key using the unscrambling function, resulting in the original private key 210:

3942749AAA098374AA9834B (step 2).

The user then selects from the application menu a command to be carried out, which, in the illustrated embodiment, is “cash winnings” (step 3), and provides his cashing transaction information, such as a bank account number.

The downloaded gaming application proceeds to hash the cashing transaction information provided by the user in step 3, and uses the unscrambled private key 210 to generate a signature for the cashing transaction information (step 4).

The signature is then transmitted, via the mobile communicator 200, to the server 202, thereby enabling the user to cash his winnings, such as by bank transfer or by any other suitable method. A serial number, identifying the instance of the application which is operating on mobile communicator 200, is also transmitted to the server 202 (step 5).

The server 202 then retrieves the user's X.509 certificate from its database 206, using the application serial number which was transmitted to the server 202 in step 5, and uses the certificate to find the user's public key and therewith to verify the user's signature which was provided in step 5 (step 6).

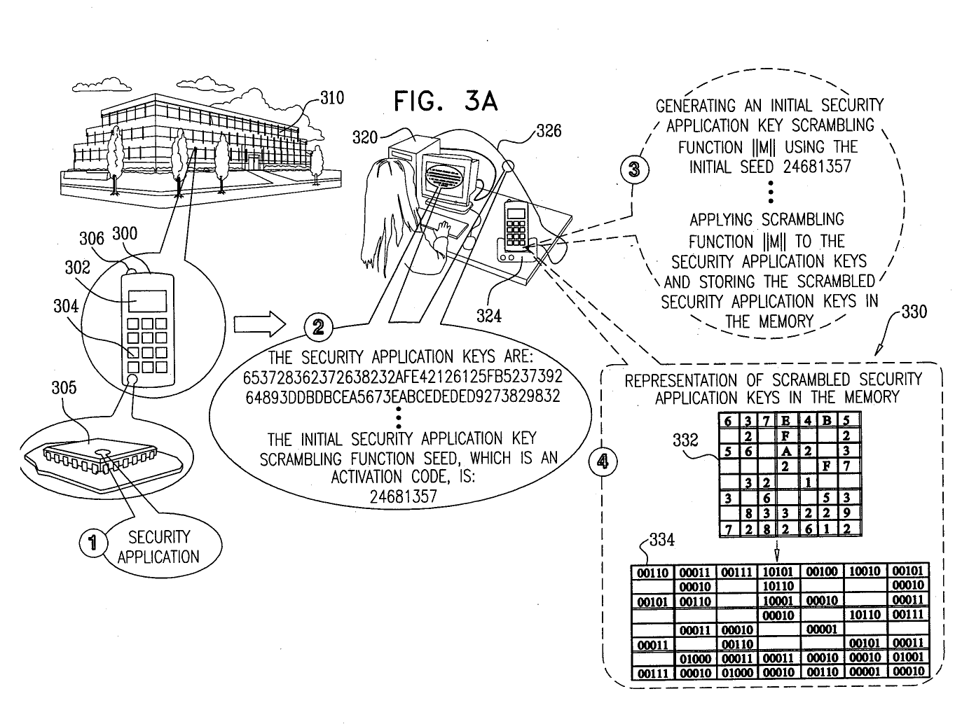

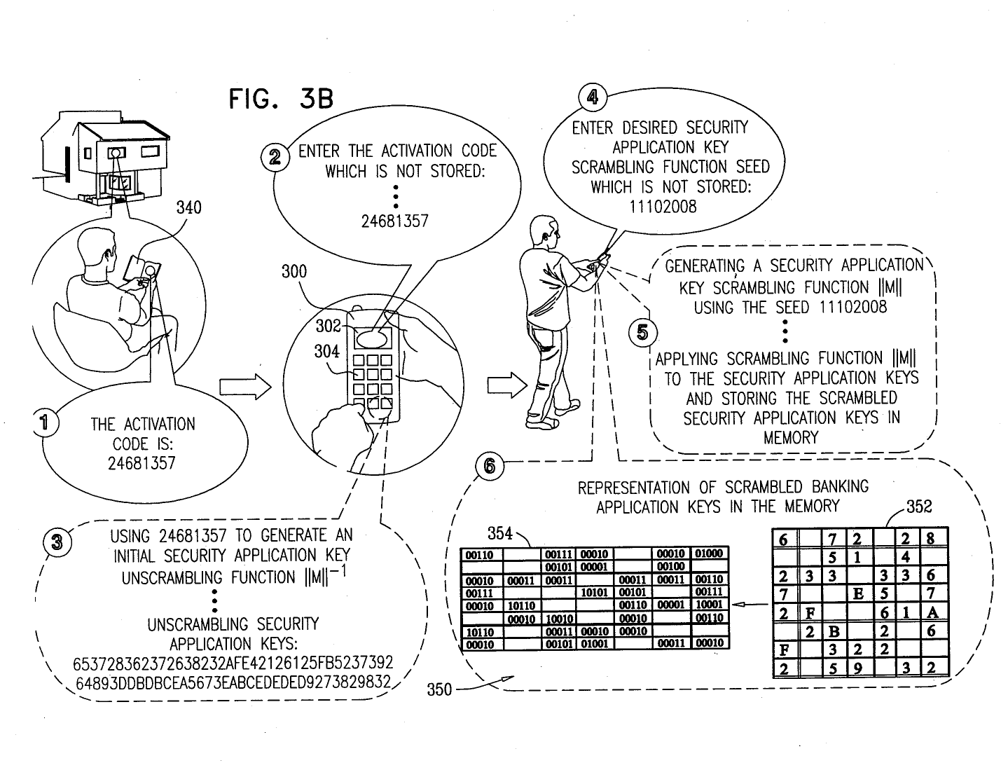

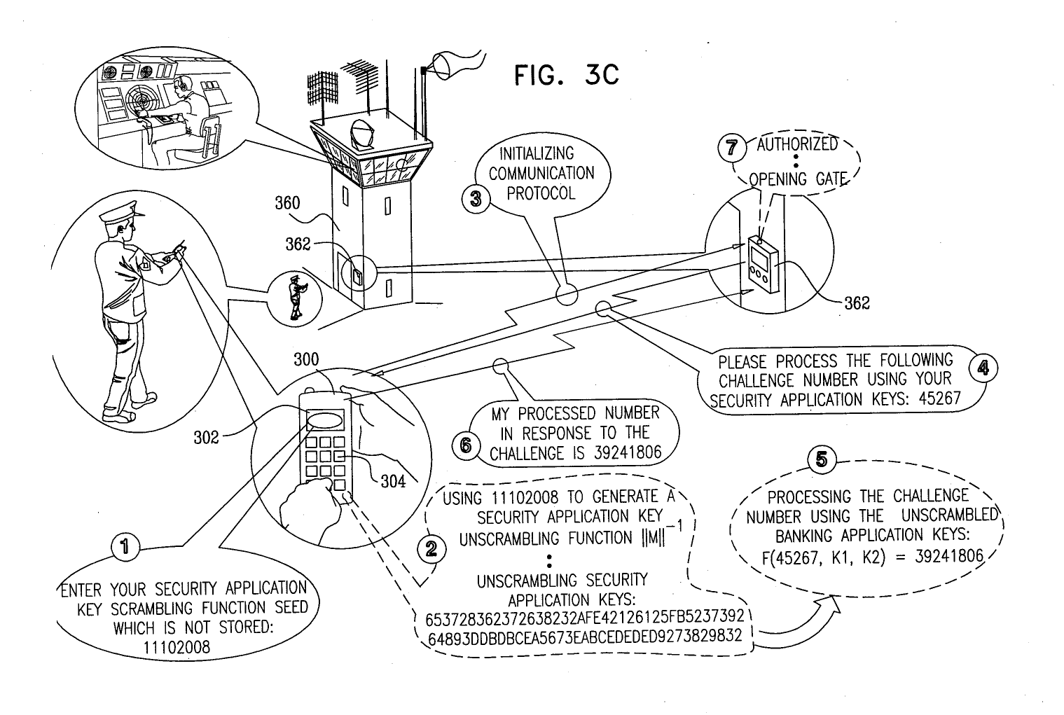

Reference is now made to FIGS. 3A, 3B and 3C, which are simplified illustrative drawings illustrating factory set up, personalized set up and use of an application key scrambling system in the exemplary context of a security related system.

As seen in FIG. 3A, a security identification tag 300, such as an RFID tag, typically includes a processor (not shown), a display 302, a keyboard 304 and a communication functionality 306, such as an antenna. During manufacturing of the tag 300 in a manufacturing facility 310, a computer chip 305, having stored thereon application software implementing a security application, is installed in the tag 300 (step 1).

Subsequently, an application initialization server 320, which may be at the manufacturing facility 310 or in any other location, generates security application keys, such as:

653728362372638232AFE42126125FB5237392; and

64893DDBDBCEA5673EABCEDEDED9273829832.

The server 320 additionally generates an initial security application scrambling function seed, such as 24681357 (step 2).

The security application keys and the initial seed are then communicated to the tag 300, typically via a hardwired communication line. In the illustrated example, the tag 300 is placed in a cradle 324, which is connected by a wire 326 to the server 320.

It is a particular feature of the present invention that the initial application key scrambling function seed is not stored in any memory used by the tag 300, whether or not that memory is removable or separate from the tag. However, the application key scrambling function seed may be stored in a computer memory which is not used by the tag 300, such as on a user's personal computer (not shown).

However, the initial application key scrambling function seed is listed as an activation code in a location which is accessible to the user, such as in a user's manual (not shown) associated with tag 300.

The application, operating on the tag 300, proceeds generates an initial scrambling function using the initial application key scrambling function seed communicated by server 320, and applies the scrambling function to the plurality of keys to obtain scrambled security application keys (Step 3). The scrambling process is described in further detail hereinbelow, with reference to FIGS. 4A-5B.

The scrambled security applications keys are stored in a memory associated with the tag 300, such as for example, a removable memory or a tag memory (Step 4), as indicated by reference numeral 330. The scrambled security application keys as stored in the memory are represented in human readable form at reference numeral 332, and in binary form at reference numeral 334.

It is appreciated that in accordance with the present invention the scrambled security application keys need not necessarily be stored in a contiguous section of the memory, and are preferably distributed within all the available space in the memory being used. Additionally, the security application keys need not necessarily be stored in areas of the memory which are dedicated to storing application data.

Turning to FIG. 3B, a user is seen during personalized set-up of the tag 300, which normally includes the selection by the user of a new seed. The manufacturing facility 310, or a service provider (not shown), provides the initial application key scrambling function seed, which is referred to hereinafter as an activation code, to the user. In the illustrated embodiment, the activation code is listed in a user's manual 340 associated with the tag 300 (step 1). It is appreciated that communication of the activation code to the user may be via any other suitable communications link, such as voice, hard copy letter, email or SMS.

Typically, when the user initially activates the security application, the user is prompted by the application to enter the activation code provided by the manufacturing facility 310 (step 2).

The security application operating on the tag 300 then retrieves the scrambled application keys from their storage locations in the memory and employs the activation code entered by the user to generate an initial application key unscrambling function, which is typically the inverse of the initial scrambling function. The security application proceeds to unscramble the application keys using the unscrambling function, resulting in the original keys, such as:

653728362372638232AFE42126125FB5237392; and

64893DDBDBCEA5673EABCEDEDED9273829832 (step 3).

Subsequently or concurrently, the user is prompted to select a personal application key scrambling function seed, and to enter the personalized application key scrambling function seed, using keyboard 304 of the tag 300 (Step 4).

It is a particular feature of the present invention that the personal application key scrambling function seed is not stored in any memory used by the tag 300, whether or not that memory is removable or separate from the tag. However, the personal application key scrambling function seed may be stored in a computer memory which is not used by the tag during day to day operation, such as on a user's personal computer (not shown).

The security application then proceeds to generate a personal scrambling function using the personal application key scrambling function seed entered by the user, and applies the personal scrambling function to the plurality of keys to obtain scrambled security application keys (Step 5). The scrambling process is described in further detail hereinbelow, with reference to FIGS. 4A-5B.

The scrambled security applications keys are stored in a memory associated with the tag 300, such as for example, a tag memory or a removable tag memory (Step 6), as indicated at reference numeral 350. The scrambled security application keys as stored in the memory are represented in human readable form at reference numeral 352, and in binary form at reference numeral 354.

It is appreciated that in accordance with the present invention the scrambled security application keys need not necessarily be stored in a contiguous section of the memory, and are preferably distributed within all the available space in the memory being used. Additionally, the security application keys need not necessarily be stored in areas of the memory which are dedicated to storing application data.

It is appreciated that the personal scrambling function is typically different from the initial scrambling function, and therefore the scrambled security application keys, resulting from application of the personal scrambling function, as stored in the memory following personalized set up of the tag 300, are different from the scrambled security application keys as stored in the memory immediately following factory set up of tag 300, as seen in FIG. 3A.

Reference is now made to FIG. 3C, which illustrates a user activating the security application on his security tag 300.

When the security application is activated, the user is prompted to enter his personal application key scrambling function seed, via the keyboard 304 of his tag 300 (step 1).

The security application operating on the tag 300 then retrieves the scrambled application keys from their storage locations in the memory and employs the personal application key scrambling function seed entered by the user to generate a personal application key unscrambling function, which is typically the inverse of the personal scrambling function. The security application proceeds to unscramble the application keys using the personal unscrambling function, resulting in the original keys, such as:

53728362372638232AFE42126125FB5237392; and

64893DDBDBCEA5673EABCEDEDED9273829832 (step 2).

The tag 300 is now ready for use in association with a security tag reader located at a secure location. In the illustrated embodiment, the user is seen approaching an airport control tower 360, having mounted on an outer wall thereof an RFID tag reader 362. The tag 300 typically communicates with the tag reader 362, and initialized a communication protocol therebetween (step 3).

The tag reader 362 transmits a challenge number, such as 45267, to the tag 300, for processing using the security application keys (step 4).

The security application operating on tag 300 then processes the challenge number provided by the tag reader 362 using the unscrambled security application keys. Typically, a multi-parameter function is employed for this purpose, such that the challenge number comprises one of the parameters of the function, and the unscrambled security application keys comprise the remaining parameters of the function. In the illustrated embodiment, the challenge response is 39241806, as indicated by reference numeral 370 (step 5).

The response to the challenge number generated by the security application is then transmitted, via the tag 300, to the tag reader 362 (step 6), which subsequently authorizes the entrance of the user into the secure location (step 7).

Optionally, the challenge response may be displayed to the user on the display 302 of the tag 300.

Reference is now made to FIGS. 4A and 4B, which, taken together, are a simplified flowchart illustrating set up procedures employed in accordance with a preferred embodiment of the present invention.

As seen in FIGS. 4A and 4B, the user downloads an application from an application server to a mobile communicator, and receives from the application server an application activation code. Communication of the activation code to the user may be via any suitable communications link, such as voice, hard copy letter, email, SMS or directly from the server.

Subsequently, the user is prompted to enter the activation code and to provide an application key scrambling function seed, which seed is not stored in any computer memory used by the mobile communicator. The application key scrambling function seed may be stored in a computer memory which is not used by the mobile communicator, such as on a user's personal computer.

The application proceeds to generate a set of user specific application keys, K₁, K₂ . . . Kₙ, and to concatenate the user specific application keys to form a vector, (K₁₁, K₁₂, . . . Kᵢⱼ, . . . Kₙₘ). The application then adds to the vector the number of characters in the representation of each of the user specific application keys, referred to hearinafter as the dimension of the keys, d₁, d₂, . . . dₙ, thereby creating the contiguous vector CV=(K₁₁, K₁₂, . . . Kᵢⱼ, . . . Kₙₘ, d₁, d₂, . . . dₙ).

The application uses the application key scrambling function seed in a deterministic random number generator, which generates a random sequence R₁, R₂ . . . R_{P}. Mathematically, this step can be expressed by: RNG (SEED)=R=R₁, R₂ . . . R_{P}.

It is appreciated that the application key scrambling function seed used by the application is that seed provided by the user, which seed is not stored in any operational memory used the mobile communicator.

The application then employs an algorithm ALG, which uses the random sequence R₁, R₂ . . . R_{P} as a seed for generating a random arrangement ∥M∥. Mathematically, this step can be expressed by: ALG(R)=∥M∥. The arrangement ∥M∥ is typically a matrix, though it is appreciated that any other suitable arrangement may be employed.

Subsequently, the application employs a function F, which uses the arrangement ∥M∥, for scrambling the contiguous vector, thereby obtaining an incontiguous vector. Mathematically, if we let CV indicate the contiguous vector, and ICV indicate the incontiguous vector, this step can be expressed by: F_{∥M∥}(CV)=ICV. For example, in a case in which ∥M∥ is a matrix, the function may be expressed as: CV×∥M∥=ICV.

The application then stores the incontiguous vector in an available memory space, in a memory used by the mobile communicator. It is appreciated that in accordance with the present invention the incontiguous vector need not necessarily be stored in a contiguous section of the memory, and is preferably distributed within all the available space in the memory being used. Additionally, the incontiguous vector need not necessarily be stored in areas of the memory which are dedicated to storing application data.

Reference is now made to FIGS. 5A and 5B, which, taken together, are a simplified flowchart of the operation of the present invention in running a protected application.

As seen in FIGS. 5A and 5B, the user accesses the application, and is then prompted to enter the application key scrambling function seed. The scrambling function seed provided by the user is not stored on any operational computer memory used by the mobile communicator at the time of accessing the application, though it may be stored in a computer memory which is not used by the mobile communicator at that time, such as on a user's personal computer.

The application operating on the mobile communicator uses the application key scrambling function seed, which was provided by the user, in the deterministic random number generator, thereby to regenerate the sequence R₁, R₂ . . . R_{P}. Mathematically, this step can be expressed by: RNG (SEED)=R=R₁, R₂ . . . R_{P}.

The application then employs the algorithm ALG, which uses the random sequence R₁, R₂ . . . R_{P} as a seed for regenerating the random arrangement ∥M∥. Mathematically, this step can be expressed by: ALG(R)=∥M∥.

Subsequently, the application inverts the function F, which uses the arrangement ∥M∥, to obtain the inverse function F⁻¹. Subsequently or concurrently, the application retrieves the incontiguous vector from its storage in the memory.

The application then applies the inverse function F⁻¹, which uses the arrangement ∥M∥, to the incontiguous vector which was retrieved from the memory, thereby to unscramble the incontiguous vector and to obtain the contiguous vector, (K₁₁, K₁₂, . . . Kᵢⱼ . . . Kₙₘ, d1, . . . , dn). Mathematically, and using the notation of FIGS. 4A and 4B, this step can be expressed by F⁻¹_{∥M∥}(ICV)=CV. For example, in a case in which ∥M∥ is a matrix, the function may be expressed as: ICV×∥M∥⁻¹=CV. In this case, the function F is multiplication by the matrix ∥M∥, and therefore the inverse function F⁻¹ comprises multiplication by the inverse matrix ∥M∥⁻¹.

The application then segments the contiguous vector (K₁₁, K₁₂, . . . Kᵢⱼ . . . . Kₙₘ, d1, . . . , dn), thereby to retrieve the user specific application keys K₁ . . . Kₙ and their respective dimensions. The application may then employ the retrieved user specific application keys for providing various application functionalities, examples of which were described hereinabove with reference to FIGS. 1A-3C.

It will be appreciated by persons skilled in the art that the present invention is not limited to what has been particularly shown and described hereinabove. Rather the scope of the present invention includes both combinations and subcombinations of various features described hereinabove as well as modifications of such features which would occur to a person of ordinary skill in the art upon reading the foregoing description and which are not in the prior art.

1. A mobile communicator comprising:
a CPU;
communications software; and
application software for at least one application which can be launched only by using at least one application key, said at least one application key being scrambled using a scrambling function which is based on a seed, which seed is not stored in any computer memory used by the mobile communicator.

2. A mobile communicator according to claim 1 and wherein, following scrambling thereof, said at least one application key is stored in a memory associated with said mobile communicator in a distributed manner.

3. A mobile communicator according to claim 2 and wherein said application employs said seed to generate an unscrambling function for unscrambling said at least one application key following retrieval thereof from said memory.

4. A mobile communicator according to claim 1 and wherein said seed is stored in a computer memory which is not used by the mobile communicator.

5. A mobile communicator according to claim 1 and wherein said application software is associated with personal user information.

6. A mobile communicator according to claim 1 and wherein said seed is provided by a user.

7. A mobile communicator according to claim 6 and wherein said user provides said seed each time said application is launched.

8. A mobile communicator according to claim 1 and wherein said application employs said at least one application key for generating a One Time Password (OTP).

9. A mobile communicator according to claim 1 and wherein said application employs said at least one application key for providing a response to a challenge provided by a challenging server.

10. A mobile communicator according to claim 1 and wherein said at least one application key comprises a private key forming part of a key pair associated with use of an asymmetric algorithm.

11. A method of securing data in a mobile communicator against unauthorized use comprising:
providing application software for at least one application which can be launched only by using at least one application key; and
scrambling said at least one application key by using a scrambling function which is based on a seed, which seed is not stored in any computer memory used by the mobile communicator.

12. A method according to claim 11, and also comprising installing and running said at least one application on the mobile communicator.

13. A method according to claim 11 and also comprising storing said at least one application key in a memory associated with said mobile communicator in a distributed manner.

14. A method according to claim 11 and also comprising storing said seed in a computer memory which is not used by said mobile communicator.

15. A method according to claim 11 and wherein said application software is associated with personal user information.

16. A method according to claim 11 and wherein said seed is provided by a user.

17. A method according to claim 16 and wherein said user provides said seed each time said application is launched.

18. A method according to claim 11 and wherein said at least one application key comprises a private key forming part of a key pair associated with use of an asymmetric algorithm.

19. A method according to claim 11 and wherein said scrambling comprises:
concatenating said at least one application key and a dimension corresponding to each of said at least one application key to form a contiguous vector; and
employing said seed in a random number generator to generate a scrambling function for scrambling said contiguous vector, thereby to obtain an incontiguous vector.

20. A method according to claim 19 and wherein said employing said seed in a random number generator to generate a scrambling function comprises:
employing said seed in a random number generator to obtain a random sequence;
employing said random sequence as a randomization seed in an algorithm, thereby to obtain a random arrangement;
using said random arrangement in said scrambling function; and
applying said scrambling function, using said random arrangement, to said contiguous vector.

21. A method according to claim 11 and also comprising employing said application and said at least one application key for generating a One Time Password (OTP).

22. A method according to claim 11 and also comprising employing said application and said at least one application key for providing a response to a challenge provided by a challenging server.

23. A method according to claim 21 and wherein said employing said application and said at least one application key comprises:
retrieving an incontiguous vector representing said at least one application key from a memory associated with said mobile communicator; and
unscrambling said incontiguous vector using an unscrambling function which is based on said seed, thereby to obtain said at least one application key.

24. A method according to claim 23 and wherein said unscrambling comprises:
employing said seed in a random number generator to obtain a random sequence;
employing said random sequence as a randomization seed in an algorithm, thereby to obtain a random arrangement;
using said random arrangement in said unscrambling function;
applying said unscrambling function, using said random arrangement, to said incontiguous vector, thereby to obtain a contiguous vector; and
segmenting said contiguous vector to retrieve said at least one application key.

25. A computer readable medium including, in computer readable form:
application software for at least one application which can be launched only by using at least one application key, said at least one application key being scrambled using a scrambling function which is based on a seed, which seed is not stored in any computer memory used by the mobile communicator.

26. A medium according to claim 25 and wherein said at least one application key is stored in a memory associated with said mobile communicator in a distributed manner.

27. A medium according to claim 25 and wherein said seed is stored in a computer memory which is not used by said mobile communicator.

28. A medium according to claim 25 and wherein said application software is associated with personal user information.

29. A medium according to claim 25 and wherein said at least one application key comprises a private key forming part of a key pair associated with use of an asymmetric algorithm.

30. A medium according to claim 25 and wherein said seed is provided by a user each time said application is launched.

31. A software module suitable for use in a mobile communicator, said software module being launchable only by using at least one application key which is scrambled using a scrambling function which is based on a seed, which seed is not stored in any computer memory used by the mobile communicator.

32. A software module according to claim 31 and wherein said at least one application key is stored in a memory associated with said mobile communicator in a distributed manner.

33. A software module according to claim 31 and wherein said seed is stored in a computer memory which is not used by said mobile communicator.

34. A software module according to claim 31 and wherein said software is associated with personal user information.

35. A software module according to claim 31 and wherein said at least one application key comprises a private key forming part of a key pair associated with use of an asymmetric algorithm.

36. A software module according to claim 31 and wherein said seed is provided by a user each time said application is launched.
